(19) United States
(12) Patent Application Publication
(10) Pub. No.: US 2010/0169225 A1
(43) Pub. Date: Jul. 1, 2010

(54) "SYSTEM FOR OUTSOURCING TECHNOLOGY SERVICES"

(76) Inventors: Gregg John Lymbery, Wellington (NZ); Stephen M. Pratt, Wellington (NZ); Jason Sew Hoy, Dunedin (NZ); Simon Edwards, Wellington (NZ)

Correspondence Address: UNISYS CORPORATION, UNISYS WAY, MAIL STATION: E8-114, BLUE BELL, PA, 19424, US

(21) Appl. No.: 12/303,989

(22) PCT Filed: Jun. 30, 2006
(86) PCT No.: PCT/US06/25677

§ 371 Date: Dec. 9, 2008

(51) Int. Cl. G06Q 10/00; G06F 3/048; G06Q 30/00; G06Q 50/00; G06F 17/30

(52) U.S. Cl. 705/80; 715/764; 705/301; 707/705; 707/E17.107

(57) ABSTRACT

A system for contracting for the provision of outsourced technology services, includes a database of services and corresponding practices for performing at least some of the services. A module is provided which enable selection of services required by a client from the database and assignment of parties responsible for delivering the selected services. A further module is arranged to prepare a contract schedule in accordance with the selected services and responsible parties. The system may also enable definition of environments of the client and metrics governing the services required by the client.

### CROSS REFERENCE TO RELATED APPLICATIONS

The present application claims the benefit of the following PCT Applications: PCT Application Number: PCT/US2006-025685 entitled, “A Method for Outsourcing Technology Services”, PCT/US2006-025678, entitled “A System for Assisting the Generation of an Agreement for Outsourcing Technology Service”; PCT/US2006-025677, entitled “A System for Outsourcing Technology Services” and PCT/US2006-025686, entitled “A Method for Facilitating the Outsourcing of Technology Services”. The subject matter of each of which is incorporated by reference herein.

### FIELD OF INVENTION

The present invention relates to a system for outsourcing technology services. More particularly, but not exclusively, the present invention relates to a system for contracting for the provision of outsourced technology services.

### BACKGROUND TO THE INVENTION

In order to reduce costs, organisations (clients) often outsource to another party (the outsourcer) the technology required in organisation. In such instances, the client generally enters into an agreement with the outsourcer in order to ensure that the technology and services to be provided are provided adequately and that there is a legally binding agreement for the provision of the outsourced services. It will be appreciated that the provision of some technology services, such as information technology services, involves a very great number of interrelated services. Consequently, reaching an agreement about the services to be provided by an outsourcer for a client can be an exceedingly complex process.

Conventional methods for entering into an outsourcing agreement include a standardised agreement, provided by the outsourcer, which is then modified to suit the requirements of the client. Alternatively, a new agreement may be created. In addition, the resultant agreement must be monitored in order to ensure that the agreed services are provided in accordance with the agreement and to ensure that the agreed services adequately meet the needs of the client.

There are several difficulties encountered when outsourcing technology. For example, it is difficult to maintain standardisation within the agreement between the client and the outsourcer while providing a client-centric approach to providing services (i.e. a customised approach). In addition, it is difficult to ascertain precise terms of the agreement, often because the agreement has not been captured adequately. Much of this is further complicated by the fact that traditional agreements are difficult to negotiate and modify as they are structured in view of the way they are negotiated and the number of people and functional groups involved.

Existing methods provide neither a structured approach to outsourcing negotiations nor do they provide for a structured approach to modifying an agreement based on monitoring of the delivery of the services agreed on. The result of existing methods of outsourcing is often an inconsistent definition of the outsourcing agreement and service demarcation because these methods are based on delivery experience rather than contract generation. In addition, there are few adequate methods of monitoring the resultant outsourcing agreement to ensure that the services are provided in accordance with the agreement and to monitor to ensure that the services contracted are adequate.

It is an object of the present invention to overcome the above disadvantages by providing a more effective system for outsourcing technology, or to at least provide the public with a useful choice.

### SUMMARY OF THE INVENTION

In a first aspect the invention provides a computer system for contracting for the provision of outsourced technology services, including: a processor and memory; the memory storing a database of services and corresponding practices for performing at least some of the services, and the processor being configured to implement: a module enabling selection of services required by a client from the database and assignment of parties responsible for delivering the selected services, and a module arranged to prepare a contract schedule in accordance with the selected services and responsible parties.

Preferably, the processor is also configured to implement a module enabling specification of environments of the client and the module enabling assignment enables assignment of a responsible party for each selected service in each specified environment of the client in which that service is to be provided, where preferably the environments are defined by one of infrastructure, data or business environments. The system preferably includes a display configured to display a graphical user interface enabling a user to specify the environments.

Each responsible party is preferably one of the outsourcer, the client, or a third party.

The processor is preferably also configured to implement a module enabling determination of metrics by agreement between the client and an outsourcer, wherein the selection of services is dependent on the metrics determined. The metrics may relate to any one or more from the set of the frequency of delivery; the quality of the service; the availability of components of the environment; and the ability of the environment to support the business. Preferably the system includes a display configured to display a graphical user interface enabling user-definition of metrics. Preferably the system includes a display configured to display a graphical user interface arranged to enable a user to select services and assign responsible parties.

Preferably the technology services are information technology services.

### BRIEF DESCRIPTION OF THE DRAWINGS

Embodiments of the invention will now be described, by way of example only, with reference to the accompanying drawings in which:

FIG. 1: shows an example of a framework of which the system of the invention may form part;

FIG. 2: shows an example of a list of services from which required services may be selected;

FIG. 3: shows an example of a table allowing selection of suppliers for selected services in each environment;

FIG. 4: shows a diagram illustrating a system of the invention;

FIG. 5: shows a screenshot of the environment module of the system;

FIG. 6: shows a screenshot of the services/responsible parties module of the system;

FIG. 7: shows a graphical user interface enabling generation of a contract schedule;

FIG. 8: shows a portion of an example schedule generated by the schedule generation module of the system; and

FIG. 9: shows one embodiment of a computer system on which the invention may be implemented.

### DETAILED DESCRIPTION OF PREFERRED EMBODIMENTS

The present invention will be described in relation to information technology services outsourcing. However, it will be appreciated that, with modifications, the system may be adapted for use with outsourcing of other technology services.

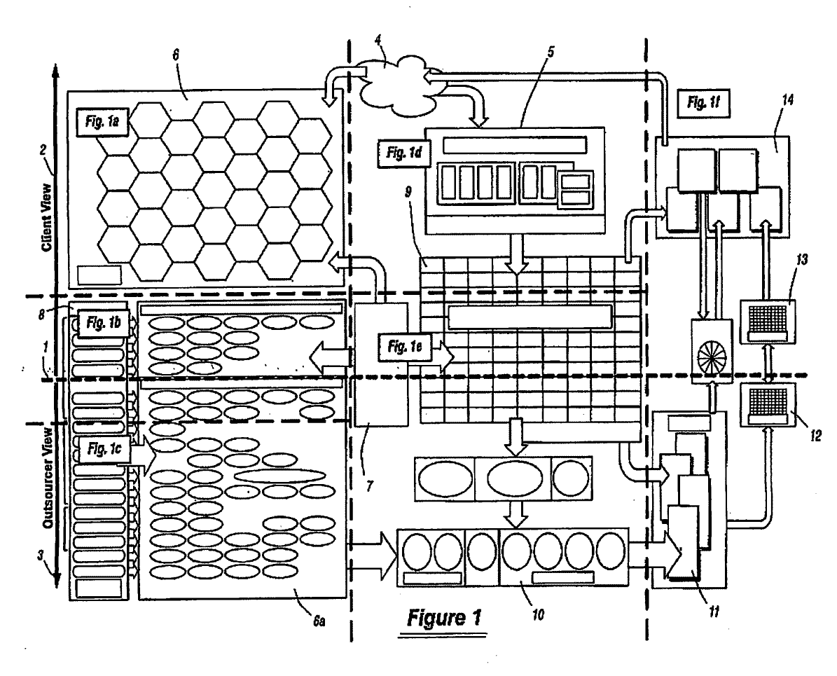

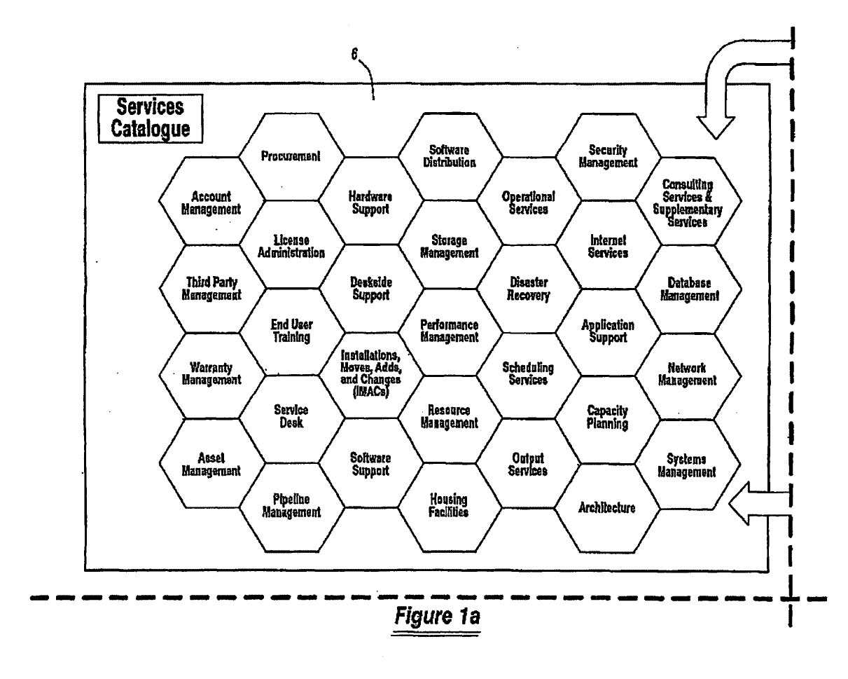

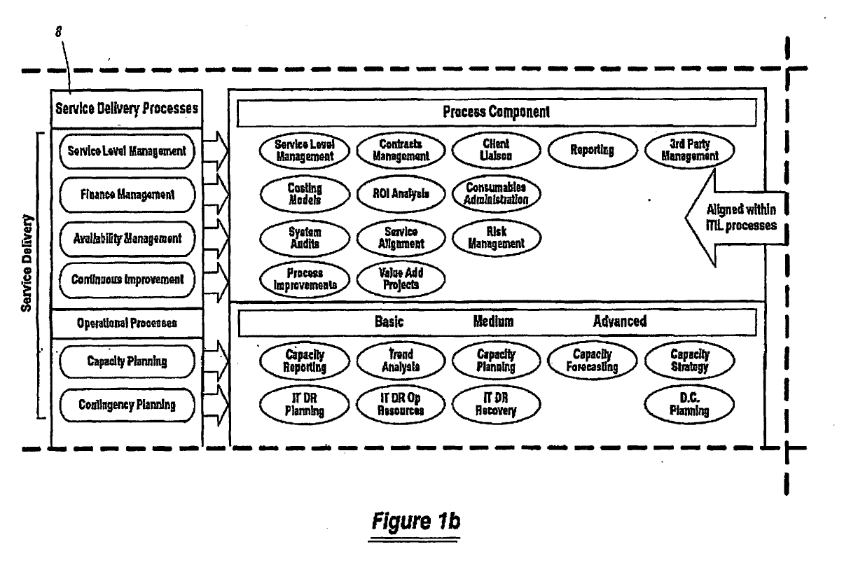

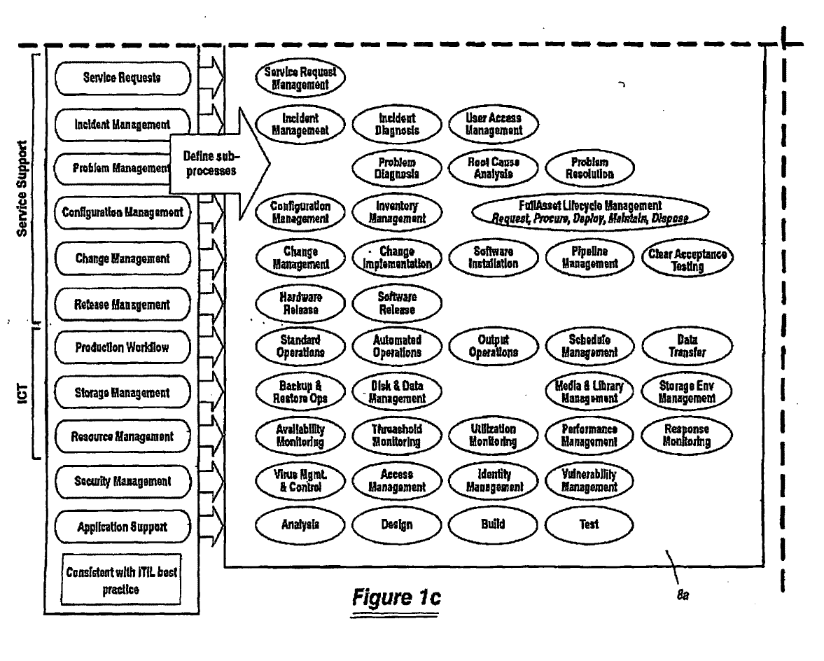

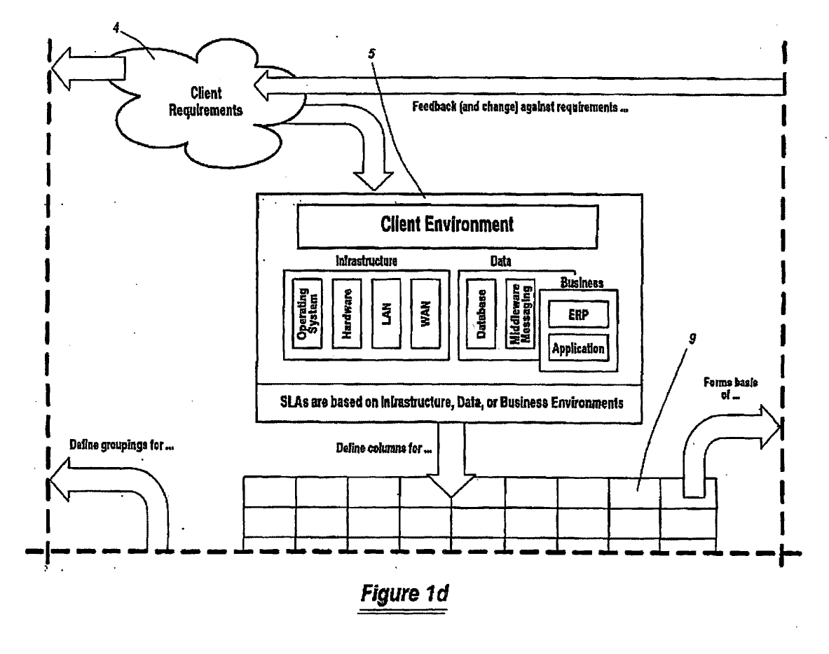

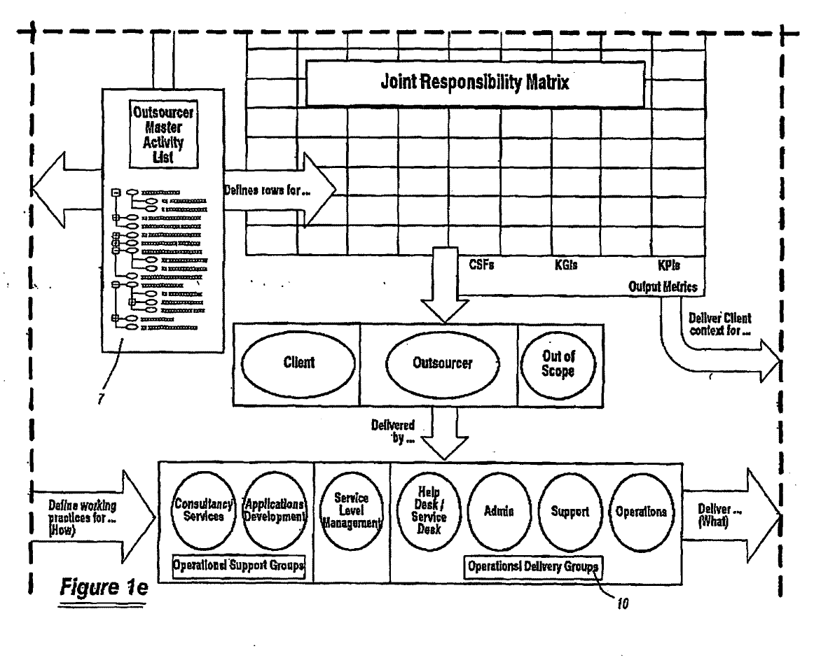

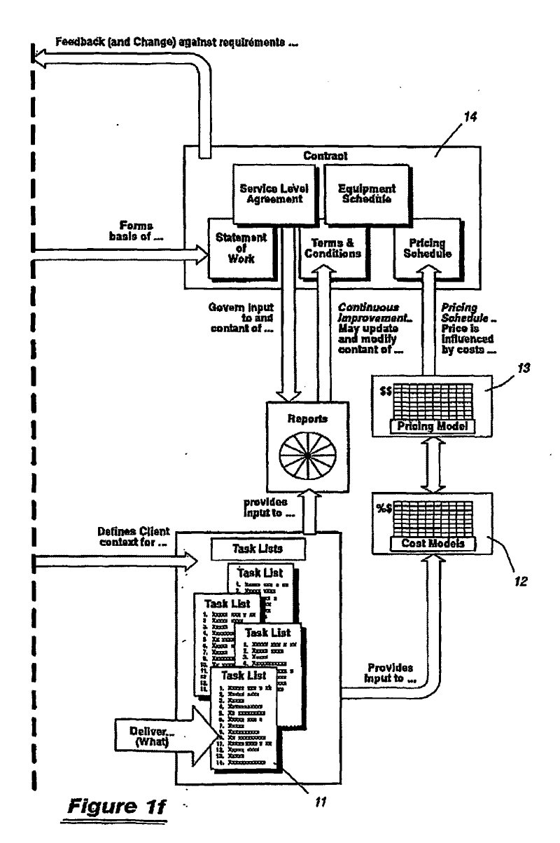

In one embodiment, the system of the invention may form part of a wider framework that facilitates a consistent approach to selling, delivering and monitoring information technology outsourcing services. FIG. 1 shows an example of such a framework. FIGS. 1a, 1b and 1c are as a whole identical to FIG. 1, but show the framework in greater detail.

With reference to FIG. 1 the components of the framework may be horizontally split along dashed line 1 into two conceptual views. In use, the client focuses on the components shown in the upper level 2. The components in the upper level relate to services required by the client and outcomes the client wants to achieve. In use, the outsourcer focuses on the components shown in the lower level 3. The components in the Lower level 3 relate to how the services will be delivered. FIG. 1 illustrates how client requirements may be translated into specific tasks to be performed by the outsourcer. This model provides clients with some visibility of the delivery model for the outsourced services but does not require exploration by the client of the specific tasks or resources required in delivering the services. Some components may require input from both the client and the outsourcer, or agreement between the client and the outsourcer, as described below.

According to the framework shown in FIG. 1, client background information and the client's requirements 4 may be gathered from the client. These requirements may be extracted during a consultative process. A full understanding by the outsourcer of the requirements and the client's technology structures assists in understanding the services the client is expecting and the services for which the outsourcer will be responsible.

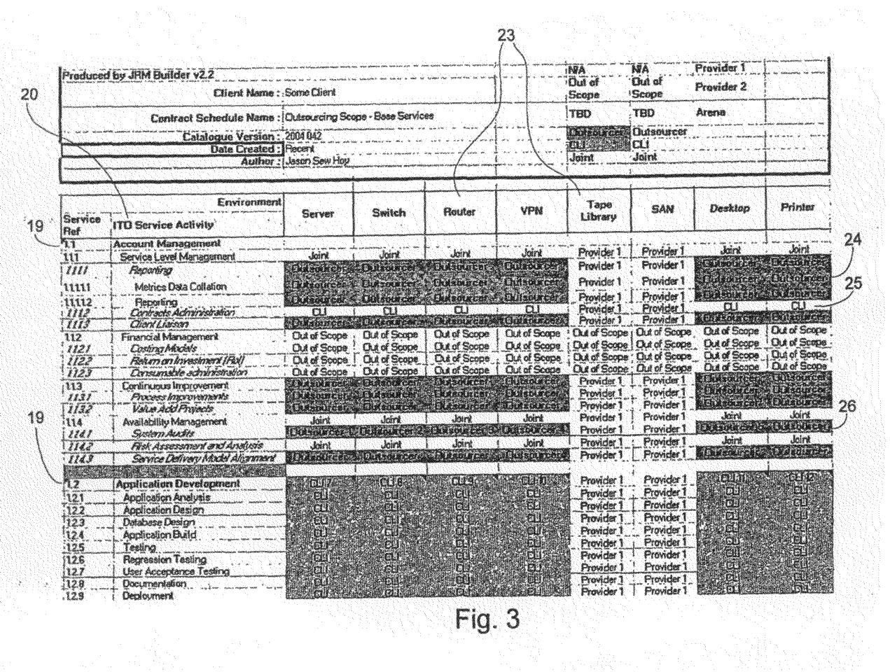

The framework preferably allows definition of the customer environments 5. The customer environments 5 provide the context in which the services are provided. This definition may take a variety of forms depending on the client requirements. For example the environment may be described at a technology level including elements such as servers, printers, routers etc. Such environments might include a server environment and a tape library environment, for example, as shown generally at 23 in FIG. 3. Alternatively the environment may be described at a business systems level including elements such as payroll system, messaging system, application system etc. Such environments might include a payroll environment and an accounts-payable environment, for example. Other environments as known to those of skill in the art may be included, and they are intended to be within the purview of the present invention. From the perspective of the outsourcer, each client environment may require a different combination of services, metrics and service levels appropriate to the technology and appropriate to the way that the services are delivered.

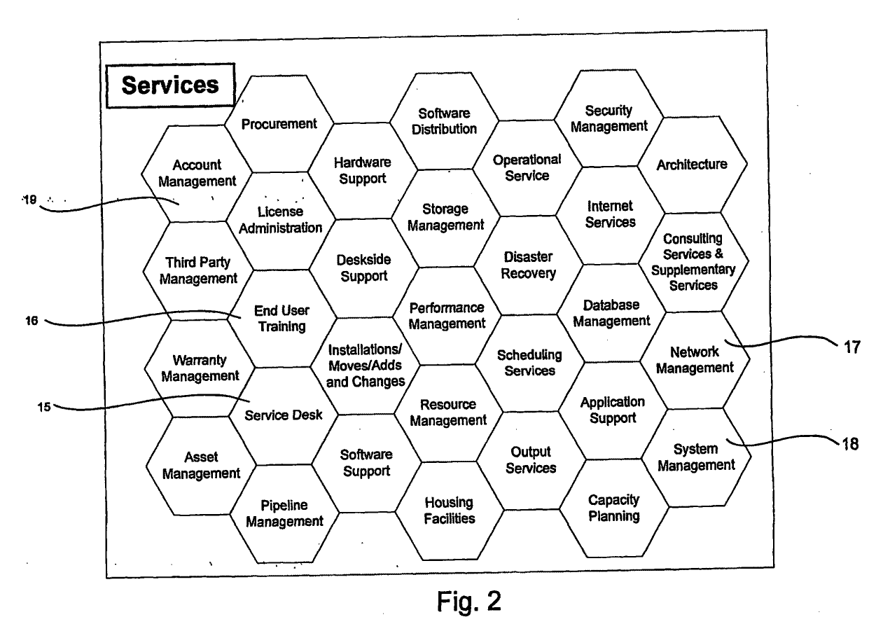

The client requirements 4 may also be used to determine the key services e.g. 15, 16, 17, 18, 19 (FIG. 2) that are to be provided in each identified environment 5. The key services e.g. 15, 16, 17, 18, 19 may be chosen from a fixed list of available services (for example, the list shown in FIG. 2), where the fixed list is a list which has resulted from a thorough consideration of the issues involved in outsourcing technology and from the extensive experience of outsourcers. The list shows what the outsourcer can deliver to the client and is preferably ordered or arranged in groups based on a functional relationship. For example, “Service Desk” is listed next to “End User Training” because service desk is related to end user training. The list or matrix may also include elements representing collections of services packaged into a well defined portfolio solution, for example, network management, and systems management. The key services shown in FIG. 2 have been developed utilising extensive experience to provide an optimal arrangement of services for an outsourcer to provide to a client. However, it will be appreciated that, although this list of key services is preferred, a modified list of services could be employed.

In the preferred embodiment the fixed list of available key services is shown as a honeycomb matrix 6, such as that shown in FIG. 2. The honeycomb matrix provides a clear high level menu of key services typically required in an information technology environment. It is also preferred that the list or matrix of key services is displayed on a graphical user interface.

The presentation of an ordered or grouped list or matrix of key services from which the client can select required services has several advantages including, but not limited to, facilitating communication of the available key services to the clients; providing high level key service descriptions to assist in scoping the outsourcing agreement; allowing the value of specific key services to be highlighted and recognised; and allowing indicative pricing to be quickly calculated. The use of this list also ensures that all relevant services are brought to the attention of the client and/or the outsourcer. It is therefore less likely that the parties will forget a particular service—their attention will necessarily be drawn to each relevant service.

Each of the key services e.g. 15, 16, 17, 18, 19 can be decomposed into a list of sub-services. In this specification, the term “services” is intended to include key services and sub-services unless the context clearly requires otherwise. The Master Activity List 7, is preferably a complete list of key services and the sub-services that make up the key services e.g. 15, 16, 17, 18, 19 in the identified environment 5. The Master Activity List 7 contains an appropriate level of detail to be used within the Statement of Work contained in the outsourcing agreement, and each sub-service in the Master Activity List 7 is specific to a single key service e.g. 15, 16, 17, 18, 19. The Master Activity List 7 also provides clarification about what aspects of the key service e.g. 15, 16, 17, 18, 19 the client requires. Each sub-service may be further decomposed into another list of services. A hierarchy of several levels of services may thus be created.

The services in the Master Activity List 7 are associated with a set of delivery processes 8. The delivery processes 8 and sub-processes 8a define a group of practices that correspond to the services in the Master Activity List 7. These practices are preferably consistent with Information Technology Infrastructure Library best practices. The ITIL is a well-known framework of supplier-independent best practice approaches for delivery of information technology (IT) services. Consistency with the ITIL therefore ensures that the services performed by the outsourcer comply with recognised information technology best practices.

The services in the Master Activity List 7 may define the rows in a Joint Responsibility Matrix 9. The Joint Responsibility Matrix 9 allows a user to define the party responsible for providing each service in the Master Activity List 7 in each environment of the client. Thus the Joint Responsibility Matrix 9 provides an easily understandable visual display, so that it is easy to see who is responsible for service-delivery, which services have yet to be assigned to a provider etc. With reference to FIG. 3 an exemplary Joint Responsibility Matrix 9 is displayed on a graphical user interface. The rows 20 of the Joint Responsibility Matrix 9 are defined by the services in the Master Activity List 7 including the key services e.g. 15, 16, 17, 18, 19 and the sub-services that make up the key services. Each key service 19 is shown as a heading using font variation, justification, and numerals. Underneath each key service 19 are sub-services related to the key service.

The columns in the Joint Responsibility Matrix 9 may be defined by the customer environments 5. As described above, the environments can be defined as any logical grouping. For example, there may be environments of the client based on geography “Los Angeles”, “Chicago” and “New York”, or based on business function—“Retail” and “Distribution”, or based on technology—“Servers” and “PCs,” such as shown in FIG. 3. It will be appreciated that a combination of logical groupings may be utilised as well, for example, “Retail Servers”, “Retail PCs”, “Distribution Servers”, and “Distribution PCs”.

Thus, each intersection 24 in the Joint Responsibility Matrix 9 is associated with a particular service in a particular environment, and each is primarily populated with the party responsible for the delivery of the respective service in the respective environment 5. The responsible parties can include the outsourcer, the client, and one or more other third party service providers. If the parties are unable to agree on a supplier for a particular service in a particular environment, but wish to return to this at a later stage of the negotiations, an indicator may be assigned to that intersection, to remind the parties that they have discussed this point and should return to it.

With further reference to FIG. 1, the outsourcer may also have a set of operational support delivery groups 10 responsible for delivering specific services. Each service in the Joint Responsibility Matrix 9 may be assigned to the most appropriate delivery group 10. For example, end user training services may be assigned to an operational delivery group devoted to providing end user training services. In this way it can be ensured that what has been requested with regard to services 15, 16, 17, 18, 19 is able to be delivered.

Task lists 11 can set out the detail of the specific tasks required to deliver the services 7 in each environment 5. The tasks are preferably defined to relate to the specific technology used by the client. The tasks are resource driven and may vary by geography and management capability.

The task lists 11 provide input into cost models 12 and pricing models 13. Cost models 12 contain assessments of the cost of delivery of the services based on what the outsourcer knows about the environments. Pricing models 13 contain assessments of the price to be charged for service delivery, based on the output of the cost models 12, scope and volume of services to be provided and the markup (i.e. profit margin) imposed by the outsourcer. The models 12, 13 are based on extensive industry experience and form part of the outsourcing contract.

The outsourcing contract 14 is designed to turn the client requirements into contractual documents. The contract 14 preferably contains a Statement of Work which may be a text version of the Joint Responsibility Matrix 9 and records the scope of the key services 15, 16, 17, 18 to be provided and clearly defines responsibility for the delivery of each service 7. The Statement of Work may be further modified to clearly document the specific client circumstances and requirements. The contract also preferably includes an equipment schedule that identifies the entire information technology infrastructure that the outsourcer is responsible for at the time of commencement of the contract. Any subsequent variation to this schedule would imply a variation in the service fees payable. The contract also includes a service level agreement which sets out the client's expectations for service delivery using metrics and service levels. These may be aimed at overall business outcomes but may also include specific measurements for a particular service. The outsourcing contract thus produced defines the relationship between the client and the outsourcer. Other contracts or agreements may also be produced between third parties and the client and/or outsourcer.

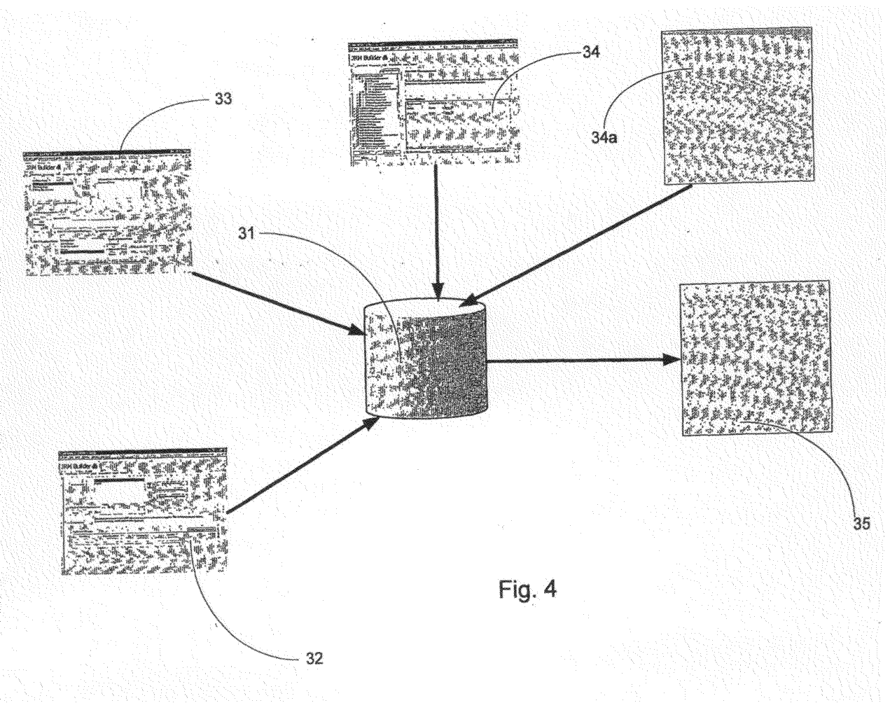

Referring to FIG. 4, a preferred embodiment of the system of the present invention will be described.

The system includes a database 31 including records of technology services. In a preferred embodiment the database includes the key services shown in FIG. 2. It is also preferred that the database includes the services contained in the Master Activity List 7 (FIG. 1) and the corresponding practices defined by the delivery processes 8 and sub-processes 8a (FIG. 1) as described above. These practices are preferably ITIL best practices for performance of the services. These may include, for example, such ITIL practices as “capacity forecasting”, “incident management” etc, and each practice has a description that shows what is actually done to implement the practice. In one embodiment of the invention the practices will also show exactly what reports are produced, and exactly what tasks or work instructions are required to produce the outputs.

The system also preferably includes one or more modules. A module may include one or more computer programs or part of a computer program and/or one or more data files or databases stored on computer readable media, the computer programs being executable on a computer processor. Each module is adapted to perform one or more functions.

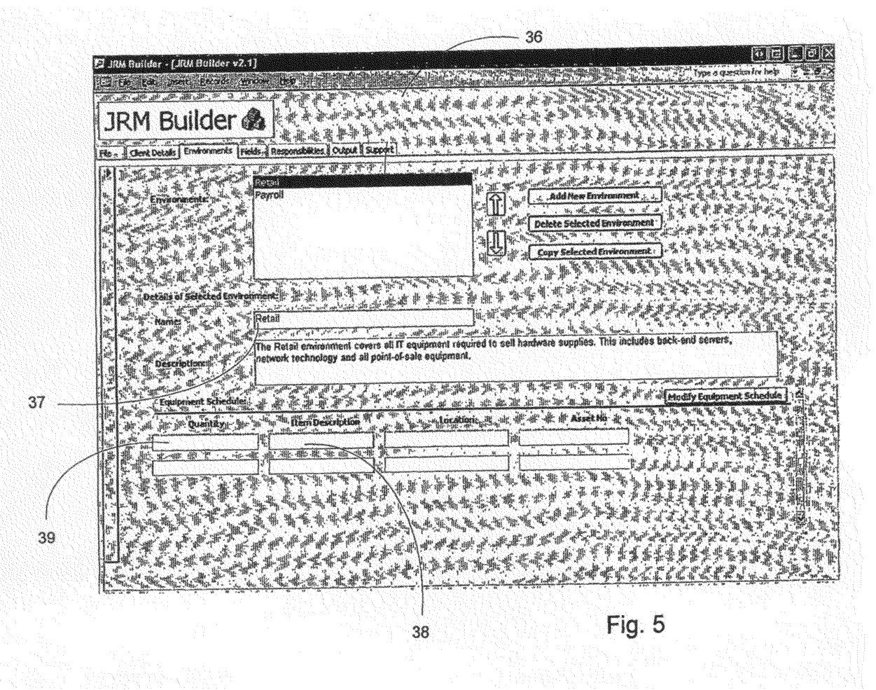

Preferably the system includes a module 32 for defining at least one environment of a client. In one embodiment the module includes a graphical user interface for receiving input from a user specifying the environments. A preferred embodiment of such a graphical user interface is shown in FIG. 5. As seen therein, the user can define an environment 36 using the freeform text box 37. There are preferably no constraints on the types of environments permitted. As described above, to reflect the client's business or other structures, the environments can be defined as any logical grouping such as infrastructure, data or business units. For example, there may be environments based on geography—“Los Angeles”, “Chicago” and “New York”, or based on business function—“Retail” and “Distribution”, or based on technology—“Servers” and “PCs”. It will be appreciated that a combination of logical groupings may be utilised as well. For example, “Retail Servers”, “Retail PCs”, “Distribution Servers”, and “Distribution PCs”.

The graphical user interface may also provide an input box 38 to receive input from a user to define hardware devices within each environment and an input box 39 to receive the quantity of each hardware device within each environment. Where environments use the same hardware, this hardware can be defined to appear in each environment. The details relating to the hardware and quantities form part of the environment's description. Additional information can be provided by a user to further describe the environment.

It will be appreciated that although the use of a graphical user interface has several advantages, including ease of use, the environments may be instead defined using a non-graphical user interface.

Referring again to FIG. 4, the system may also include a module 33 that enables a user to specify all parties that are relevant to the outsourcing agreement. The parties can include the outsourcer, the client, and any third parties.

The system also includes a module 34 that enables selection of services required by the client from the database 31 and also enables the assignment of parties responsible for delivering the selected services. This module may implement the Joint Responsibility Matrix 9 shown in FIGS. 1 and 3. In such an instance, a responsible party is assigned for each service in each environment in which that service is to be provided.

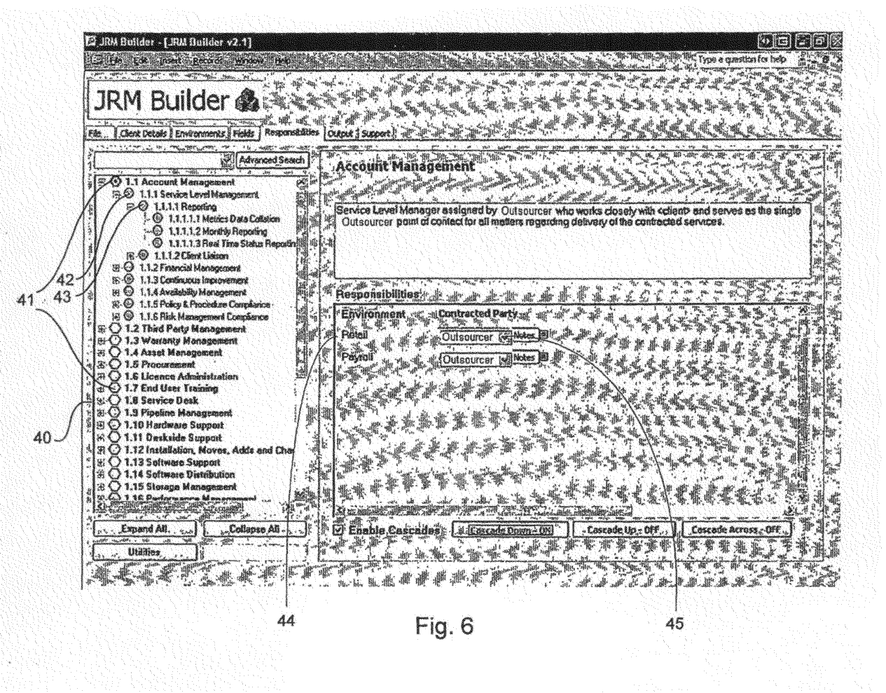

In one embodiment the module 34 also includes a graphical user interface for receiving input from a user to select the services. An example of this graphical user interface is shown in FIG. 6. The interface may display a list 40 of key services 41 within a list window. Some of the services 41 can be expanded to display a sub-list of services 42 related to that key service 41. Furthermore, some of services within the sub-list 42 can be expanded to display a list of associated services 43 related to that service 42. Every single available service can be displayed by expanding all the expandable services. It will be appreciated that this service hierarchy can be deeper than three levels.

The services are preferably listed on functional grounds, preferably being listed in the following order within the list box: account management, third party management, warranty management, asset management, procurement, license administration, end user training, service desk, pipeline management, hardware support, deskside support, installations/moves/adds and changes, software support, software distribution, storage management, performance management, resource management, housing facilities, operational service, disaster recovery, scheduling services, output services, security management, Internet services, application support capacity planning, architecture, consulting services & supplementary services, data management, network management, and system management.

The services may also be listed on other suitable grounds such as administrative grounds. The graphical user interface may also display a description of each service, which more explicitly states what the service is providing. For example, the description for “Service Desk” may be “Provision of a point of contact to log service requests”. Alternatively, a more detailed description could be provided, such as: “Event management of all service requests, including: logging, diagnosing and managing incoming calls; prioritising calls against agreed Service Levels; determining the action required to resolve calls; and managing calls through to resolution. The Service Desk also conducts user satisfaction surveys to benchmark and improve user satisfaction in regard to their Service Desk experience.”

When a service within the list box is selected by a user, the graphical user interface may display the environments 44 of the client within which the selected service is to be provided. The interface may also enable the assignment of a responsible party 45 for delivering the selected service in each of the environments 44. In a preferred embodiment the responsible party is specified by selecting a party from a drop down box of all potential responsible parties. Preferably the potential responsible parties relate to the parties specified by using module 33

It will be appreciated that although the above embodiment of using a graphical user interface has several advantages, including ease of use, the services may be selected and responsible parties assigned using a non-graphical user interface.

At any stage in the system the user can change back to the environments screen to add further environments. The user can also add additional responsible parties to the available responsible parties.

Returning once again to FIG. 4, the system further includes a module 35 for preparing a contract schedule in accordance with the selected services and the responsible parties. The contract schedule includes information relating to services, environments and responsible parties. This module 35 may also allow additional information to be specified related to the performance of a service in an environment. The information is preferably allowed to be entered as free-form text by a user. This allows a user to input customised information relating to supply of a particular service in a particular environment. This further information will preferably be included in the final contract schedule.

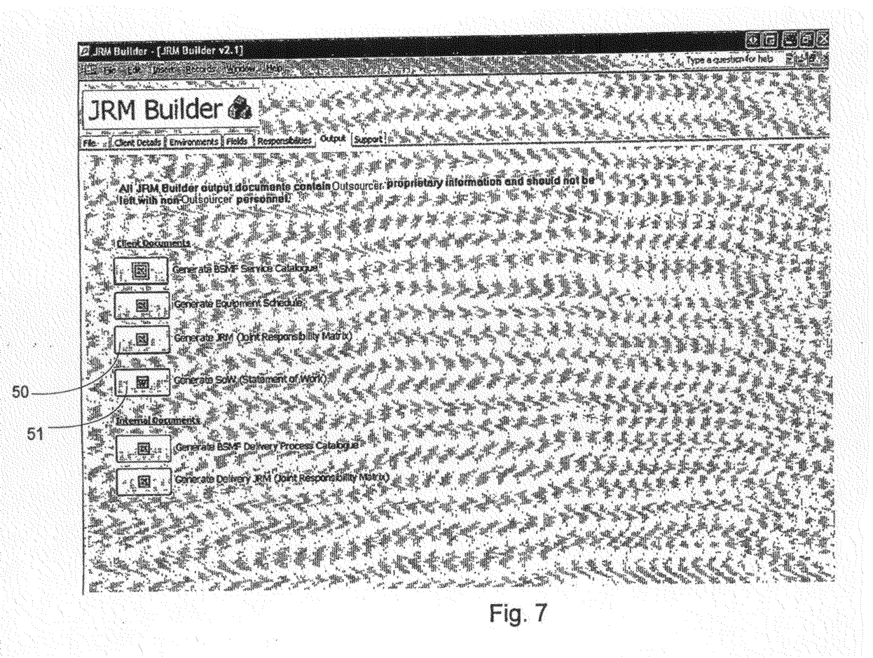

The system may also provide a graphical user interface as shown in FIG. 7. Using this interface the user can request the generation of a Joint Responsibility Matrix by selecting button 50. The user may also request the generation of a Statement of Work 51 to be used as a contract schedule.

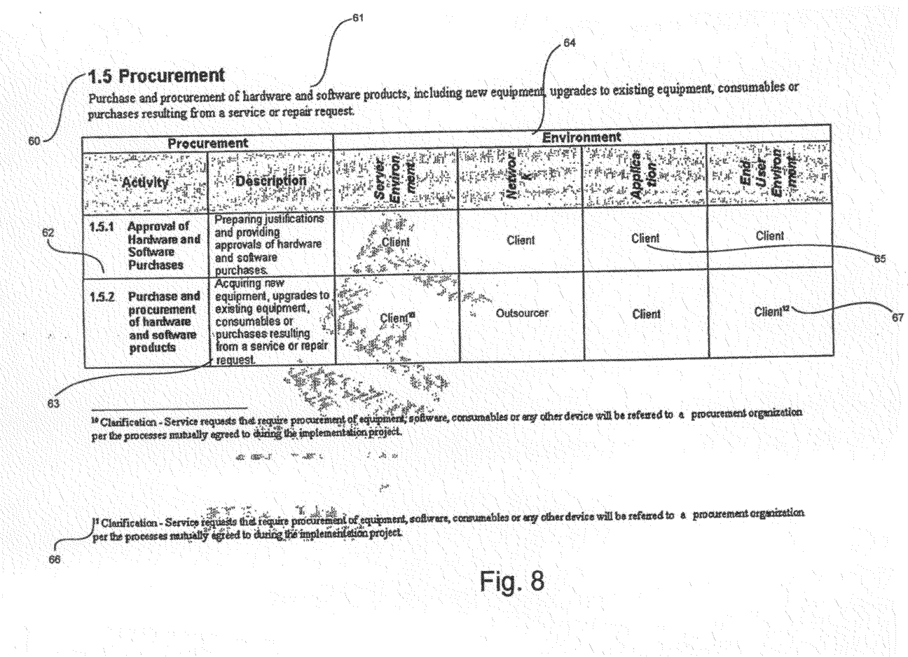

An example of a portion of a contract schedule generated by the module 35 is shown in FIG. 8. The contract schedule extract includes a statement of the key service to which it relates 60 and a description of that service 15, 16, 17, 18. The schedule also shows a sub-list of services 62 including their descriptions 63. The environments 64 in which the services are to be provided are also shown. The party responsible 65 for the provision of each service in each environment is shown in the intersections of the table. The schedule may also include further information relating to the provision of a particular service in a particular environment, in the form of footnotes 66. This information may be associated with a particular intersection by a reference numeral 67. Other methods of showing such information may also be suitable.

One embodiment of the invention will now be described where the system is used in conjunction with negotiations between an outsourcer and the client of the outsourcer to establish which services are to be provided, who is to provide the services, and to what level (quality) are the services are provided.

In this embodiment of the invention the system also includes a module (labelled 34a in FIG. 4) to capture metrics discussed during the negotiations. The outsourcer and the client determine what metrics should be used to govern the services. This is essentially a discussion process, in which an experienced outsourcing consultant assists the client. These metrics will be used in the selection of services are to be provided and determination of the level at which the services are to be provided, and can relate to any of frequency of delivery; the quality of the service; the availability of components of the environment; and the ability of the environment to support the business. Some key metrics that can be used are Critical Success Factor (CSF), Key Goal Indicator (KGI), and/or Key Performance indicator (KPI). A CSF is an aspect or condition that is required for optimal success or an activity recommend for optimal success. A KGI, representing a process goal, is a measure of what has to be accomplished. It is a measurable indicator of the process achieving its goals, often defined as a target to be achieved. A KPI is a measure of how well the process is performing. For example, the client and the consultant might determine that a service desk for the client is required to handle 500 phone calls a day. Then the metric for Service Desk is 500 calls per day. The metrics can be selected within a graphical user interface or defined by a user within a graphical user interface.

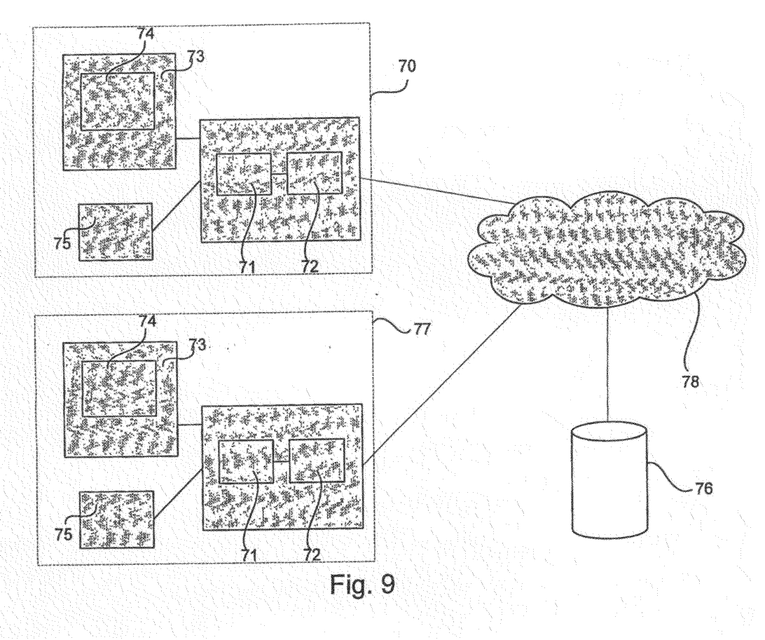

FIG. 9 shows an embodiment of a computer system according to the invention. The computer system may simply comprise a computer 70 including a computer processor 71 and computer memory 72. The computer 70 preferably includes a visual display device 73 capable of displaying a graphical user interface 74. The computer preferably also includes an input device 75 such as a keyboard. Computer software suitable for implementing the method described above may be stored on a suitable medium such as the computer memory 72. Required databases may also be stored in computer memory 72. Of course, such a computer may also communicate with one or more external databases 76 and/or other computers 77 over a network 78 in order to implement the invention. It will be appreciated that the system can be developing using one of any number of programming languages and can be deployed within many hardware configurations.

The system of the invention provides the following advantages:
The generation of an outsourcing contract is simplified and streamlined.
The graphical presentation of the contract schedule makes it is easier to see who is delivering each service, where service delivery is inconsistent or inappropriate within an environment, and where service delivery and the groups providing can be rationalised to help reduce costs.
it is easier to see if all the necessary services have been allocated to a responsible party.
It is easier to ensure responsibility for all necessary services has been allocated
it is easier to add current information (delivery performance, improvement initiatives etc) to the contract information.
It is easier to modify as things change and to assess the impact of imminent change.
The scope of responsibility of each party is clearly and more accurately captured in the outsourcing agreement.
The invention is able to present all of the services for a contract on a simple graphical user interface.
It is easier to identify gaps in the delivery of the services.
A fixed list of services enables all relevant issues to be considered.
It is possible to add further information in a simple manner and to view the services, environments, suppliers and an indication of whether such further information has been added in a single, accessible matrix. This provides an accessible overview of the agreement, reducing error and required time and effort, but providing flexibility in terms of contract content.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A computer system for contracting for the provision of outsourced technology services, including:
a processor and memory;
the memory storing a database of services and corresponding practices for performing at least some of the services, and
the processor being configured to implement:
i. a module enabling selection of services required by a client from the database and assignment of parties responsible for delivering the selected services, and
ii. a module arranged to prepare a contract schedule in accordance with the selected services and responsible parties.

2. The system as claimed in claim 1, wherein the processor is also configured to implement a module enabling specification of environments of the client.

3. The system as claimed in claim 2 wherein the module enabling assignment enables assignment of a responsible party for each selected service in each specified environment of the client in which that service is to be provided.

4. The system of claim 2, wherein the environments are defined by one of infrastructure, data or business environments.

5. The system as claimed in claim 2, including a display configured to display a graphical user interface enabling a user to specify the environments.

6. The system as claimed in claim 1, wherein each responsible party is one of the outsourcer, the client, or a third party.

7. The system as claimed in claim 1, wherein the processor is also configured to implement a module enabling determination of metrics by agreement between the client and an outsourcer, wherein the selection of services is dependent on the metrics determined.

8. The system as claimed in claim 7, wherein the metrics relate to any one or more from the set of the frequency of delivery; the quality of the service; the availability of components of the environment; and the ability of the environment to support the business.

9. The system as claimed in claim 7, further including a display configured to display a graphical user interface enabling user-definition of metrics.

10. The system of claim 1, including a display configured to display a graphical user interface enabling a user to select services and assign responsible parties.

11. The system as claimed in claim 1, wherein the technology services are information technology services.
